(19) United States
(12) Patent Application Publication
(10) Pub. No.: US 2004/0151170 A1
(43) Pub. Date: Aug. 5, 2004

(54) Management of received data within host device using linked lists

(76) Inventors: Manu Gulati, San Francisco, CA (US); Laurent R. Moll, Saratoga, CA (US)

Correspondence Address: GARLICK HARRISON & MARKISON LLP, P.O. BOX 160727, AUSTIN, TX, 78716-0727, US

(21) Appl. No.: 10/675,745

(22) Filed: Sep. 30, 2003

Related U.S. Application Data
(63) Continuation-in-part of application No. 10/356,661, filed on Jan. 31, 2003.

(51) Int. Cl. H04L 12/50

(52) U.S. Cl. 370/360

(57) ABSTRACT

A received data processing and storage system includes an input that receives data blocks corresponding to a plurality of input virtual channels. A routing module inspects the received data blocks and determines an output virtual channel for the data blocks based upon their respective input virtual channels. A receiver buffer instantiates input virtual channel linked lists, output virtual channel linked lists, and a free list. A linked list control module uses input virtual channel linked list registers, output virtual channel linked list registers, and free linked list registers to manage the linked lists instantiated by the receiver buffer. An output transmits data blocks corresponding to the plurality of output virtual channels. Data blocks are stored in the receiver buffer in both input virtual channel link lists and output virtual channel linked lists.

### CROSS REFERENCES TO RELATED APPLICATIONS

The present application is a continuation-in-part of and claims priority under 35 U.S.C. 120 to the following application, which is incorporated herein for all purposes:

(1) U.S. Regular Utility Application entitled PACKET DATA SERVICE OVER HYPERTRANSPORT LINK(S), having an application number of 10/356,661, and a filing date of Jan. 31, 2003.

### BACKGROUND OF THE INVENTION

1. Technical Field

The present invention relates generally to data communications and more particularly to the storage and processing of received high-speed communications.

2. Description of Related Art

As is known, communication technologies that link electronic devices are many and varied, servicing communications via both physical media and wirelessly. Some communication technologies interface a pair of devices, other communication technologies interface small groups of devices, and still other communication technologies interface large groups of devices.

Examples of communication technologies that couple small groups of devices include buses within digital computers, e.g., PCI (peripheral component interface) bus, ISA (industry standard architecture) bus, USB (universal serial bus), SPI (system packet interface), among others. One relatively new communication technology for coupling relatively small groups of devices is the HyperTransport (HT) technology, previously known as the Lightning Data Transport (LDT) technology (HyperTransport I/O Link Specification “HT Standard”). One or more of these standards set forth definitions for a high-speed, low-latency protocol that can interface with today's buses like AGP, PCI, SPI, 1394, USB 2.0, and 1Gbit Ethernet, as well as next generation buses, including AGP 8x, Infiniband, PCI-X, PCI 3.0, and 10Gbit Ethernet. A selected interconnecting standard provides high-speed data links between coupled devices. Most interconnected devices include at least a pair of input/output ports so that the enabled devices may be daisy-chained. In an interconnecting fabric, each coupled device may communicate with each other coupled device using appropriate addressing and control. Examples of devices that may be chained include packet data routers, server computers, data storage devices, and other computer peripheral devices, among others. Devices that are coupled via the HT standard or other standards are referred to as being coupled by a “peripheral bus.”

Of these devices that may be chained together via a peripheral bus, many require significant processing capability and significant memory capacity. Thus, these devices typically include multiple processors and have a large amount of memory. While a device or group of devices having a large amount of memory and significant processing resources may be capable of performing a large number of tasks, significant operational difficulties exist in coordinating the operation of multiple processors. While each processor may be capable of executing a large number of operations in a given time period, the operation of the processors must be coordinated and memory must be managed to assure coherency of cached copies. In a typical multi-processor installation, each processor typically includes a Level 1 (L1) cache coupled to a group of processors via a processor bus. The processor bus is most likely contained upon a printed circuit board. A Level 2 (L2) cache and a memory controller (that also couples to memory) also typically couples to the processor bus. Thus, each of the processors has access to the shared L2 cache and the memory controller and can snoop the processor bus for its cache coherency purposes. This multi-processor installation (node) is generally accepted and functions well in many environments.

However, network switches and web servers often times require more processing and storage capacity than can be provided by a single small group of processors sharing a processor bus. Thus, in some installations, a plurality of processor/memory groups (nodes) is sometimes contained in a single device. In these instances, the nodes may be rack mounted and may be coupled via a back plane of the rack. Unfortunately, while the sharing of memory by processors within a single node is a fairly straightforward task, the sharing of memory between nodes is a daunting task. Memory accesses between nodes are slow and severely degrade the performance of the installation. Many other shortcomings in the operation of multiple node systems also exist. These shortcomings relate to cache coherency operations, interrupt service operations, etc.

While peripheral bus interconnections provide high-speed connectivity for the serviced devices, servicing a peripheral bus interconnection requires significant processing and storage resources. A serviced device typically includes a plurality of peripheral bus ports, each of which has a receive port and a transmit port. The receive port receives incoming data at a high speed. This incoming data may have been transmitted from a variety of source devices with data coming from the variety of source devices being interleaved and out of order. The receive port must organize and order the incoming data prior to routing the data to a destination resource within the serviced device or to a transmit port that couples to the peripheral bus fabric. The process of receiving, storing, organizing, and processing the incoming data is a daunting one that requires significant memory for data buffering and significant resources for processing the data to organize it and to determine an intended destination. Efficient structures and processes are required to streamline and hasten the storage and processing of incoming data so that it may be quickly routed to its intended destination.

### BRIEF SUMMARY OF THE INVENTION

A received data processing and storage system overcomes the above-described shortcomings, among other shortcomings. At its input the system receives data blocks corresponding to a plurality of input virtual channels. A routing module of the system inspects the received data blocks and determines an output virtual channel for the data blocks based upon their header, protocol, source identifier/address, and destination identifier/address, among other information. A receiver buffer of the system operates to instantiate an input virtual channel linked list for storing data blocks on an input virtual channel basis, to instantiate an output virtual channel linked list for storing data blocks on an output virtual channel basis, and/or to instantiate a free list that identifies free data locations. A linked list control module of the system operably couples to the receiver buffer and manages input virtual channel linked list registers, output virtual channel linked list registers, and free linked list registers. The linked list control module uses the input virtual channel linked list registers, the output virtual channel linked list registers, and the free linked list registers to manage the linked lists instantiated by the receiver buffer. The received data processing and storage system may also include an output that transmits data blocks corresponding to the plurality of output virtual channels. The received data processing and storage system may reside within a receiver portion of a peripheral bus port of a host processing system.

The received data processing and storage system may include an input virtual channel to output virtual channel map that is employed to place incoming data blocks directly into corresponding output virtual channel linked lists of the receiver buffer. In many operations the output virtual channel will not be known upon the receipt of a data block and the data block will be placed into a corresponding input virtual channel linked list of the receiver buffer. Then, when the output virtual channel is determined for the data block, the data block is added to the corresponding output virtual channel of the receiver buffer and removed from the corresponding input virtual channel linked list of the receiver buffer. The input virtual channel to output virtual channel map may also be employed during output operations in which data blocks, stored on an input virtual channel basis are output on an output virtual channel basis. In this embodiment the receiver buffer does not instantiate output virtual channel linked lists and all data blocks are stored on the basis of input virtual channels.

The receiver buffer is organized into a pointer memory, a data memory, and a packet status memory. With this organizational structure, a single address addresses corresponding locations of the pointer memory, the data memory, and the packet status memory. The packet status memory stores information relating to packet state and may include start of packet information, end of packet information, and packet error status, etc. The received data processing and storage system may include a pointer memory read port, a pointer memory write port, a data memory read port, a data memory write port, a packet status memory read port, and a packet status memory write port. With this structure a single pointer memory location can be read from and written to in a common read/write cycle, a single data memory location can be read from and written to in the common read/write cycle, and a single packet status memory location can be read from and written to in the common read/write cycle. Moreover, differing locations within each of these memories may be read from and written to in a single read/write cycle so long as each memory is only written to and read from a single time in each read/write cycle.

A method for routing data within a host device includes receiving a data block at a receiver of the host device, the data block received via an input virtual channel, storing the data block in a receiver buffer, and updating an input virtual channel linked list corresponding to the input virtual channel to include the data block. The method further includes processing the data block to determine an output virtual channel for the data block and storing the relationship between the input virtual channel and an output virtual channel. The method then includes transferring the data block from the receiver buffer to a destination within the host device based upon the output virtual channel linked list and updating the input virtual channel linked list to remove the data block.

Another method for routing data within the host device includes maintaining a plurality of input virtual channel linked lists, a plurality of output virtual channel linked lists, and a free linked list. With this embodiment, when incoming data blocks are already associated with output virtual channels they are placed directly in corresponding output virtual channel linked lists. However, when their corresponding output virtual channels are not known, they are temporarily placed into input virtual channel linked lists and later moved to the output virtual channel linked lists and output therefrom.

A data write operation into an input virtual channel linked list is performed by storing the data block in the receiver buffer at a location identified by the free linked list head address. The input virtual channel linked list is then updated to include the data block and the free linked list is updated to remove the receiver buffer location. These operations are accomplished by: (1) reading a new free linked list head address from the receiver buffer at an old free linked list head address; (2) writing the new free linked list head address to a free linked list head register; (3) writing the old free linked list head address to the receiver buffer at an old input virtual channel linked list tail address; and (4) writing the old free linked list head address to an input virtual channel linked list tail register.

A data write operation into an output virtual channel linked list is performed by storing the data block in the receiver buffer at a location identified by the free linked list head address. The output virtual channel linked list is then updated to include the data block and the free linked list is updated to remove the receiver buffer location. These operations are accomplished by: (1) reading a new free linked list head address from the receiver buffer at an old free linked list head address; (2) writing the new free linked list head address to a free linked list head register; (3) writing the old free linked list head address to the receiver buffer at an old output virtual channel linked list tail address; and (4) writing the old free linked list head address to an output virtual channel linked list tail register.

A read operation is performed when a data block is transferred from the receiver buffer to a destination within the host device. The data block from an output virtual channel linked list. This operation includes reading the data block from the receiver buffer at an old output virtual channel linked list head address, updating the output virtual channel linked list to remove the data block, and updating the free list to include the receiver buffer location at the old output virtual channel linked list head address. Operations include: (1) reading a new output virtual channel linked list head address from the receiver buffer at the old output virtual channel linked list head address; (2) writing the new output virtual channel linked list head address to an output virtual channel linked list head register; (3) writing the old output virtual channel linked list head address to the receiver buffer at an old free linked list tail address; and (4) writing the old output virtual channel linked list head address to a free linked list tail register.

Reading a data block from an input virtual channel linked list includes reading the data block from the receiver buffer at an old input virtual channel linked list head address, updating the input virtual channel linked list to remove the data block, and updating the free list to include the receiver buffer location at the old input virtual channel linked list head address. Operations include: (1) reading a new input virtual channel linked list head address from the receiver buffer at the old input virtual channel linked list head address; (2) writing the new input virtual channel linked list head address to an input virtual channel linked list head register; (3) writing the old input virtual channel linked list head address to the receiver buffer at an old free linked list tail address; and (4) writing the old input virtual channel linked list head address to a free linked list tail register.

A combined read/write operation is performed when a data block is read from the receiver buffer at a location corresponding to an output virtual channel linked list head address, the location is removed from the output virtual channel linked list, a new data block is written into the receiver buffer location, and either the input virtual channel linked list or an output virtual channel linked list is updated to include the new data block. This operation may be performed in a single read/write cycle using the read port and write port corresponding to the data portion of the receiver buffer and the read port and write port corresponding to the pointer portion of the receiver buffer. In this operation a first data block is read from the receiver buffer and a second data block is written to the receiver buffer. This operation includes: (1) reading the first data block and a new output virtual channel head address from the receiver buffer at the old output virtual channel head address; (2) writing the new output virtual channel head address to the output virtual channel head register; (3) writing the second data block to the receiver buffer at the old output virtual channel head address; (4) writing the old output virtual channel head address to an output virtual channel tail register; and (5) writing the old output virtual channel head address to the receiver buffer at the old output virtual channel head address. The combined read/write operations may be performed in a single read/write cycle and will not alter the free linked list.

An additional technique for streamlining the operations of the system includes anticipating the write of a data block to the receiver buffer in a subsequent read/write cycle by reading a new free linked list head address from the receiver buffer at an old free linked list head address in a current read/write cycle. By combining a receiver buffer read operation with a receiver buffer write operation, the rate at which data may be put through the receiver buffer increases resulting in increased system performance. Further, the receiver buffer is more efficiently used so that a smaller receiver buffer may be used.

Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 is a schematic block diagram of a processing system in accordance with the present invention;

FIG. 2 is a schematic block diagram of a multiple processor device in accordance with the present invention;

FIG. 3 is a schematic block diagram of the multiple processor device of FIG. 2 illustrating the flow of transaction cells between components thereof in accordance with the present invention;

FIG. 4A is diagram illustrating a transaction cell constructed according to one embodiment of the present invention that is used to route data within the multiple processor device of FIG. 2;

FIG. 4B is a diagram illustrating an agent status information table constructed according to an embodiment of the present invention that is used to schedule the routing of transaction cells within the multiple processor device of FIG. 2;

FIG. 5 is a graphical representation of transporting data between devices in accordance with the present invention;

FIG. 6 is a schematic block diagram of a receiver media access control module in accordance with the present invention;

FIG. 7 is a graphical representation of the processing performed by a transmitter media access control module and a receiver media access control module in accordance with the present invention;

FIG. 8 is a schematic block diagram illustrating one embodiment of one portion of a receiver media access control module in accordance with the present invention;

FIG. 9 is a schematic block diagram illustrating another embodiment of one portion of a receiver media access control module in accordance with the present invention;

FIG. 10 is a block diagram illustrating the structure of a linked list in accordance with the present invention;

FIG. 11 is a logic diagram illustrating a first embodiment of a method for processing incoming data blocks in accordance with the present invention;

FIG. 12 is a logic diagram illustrating a second embodiment of a method for processing incoming data blocks in accordance with the present invention;

FIG. 13A is a logic diagram illustrating operation in updating an input virtual channel linked list to include a data block;

FIG. 13B is a logic diagram illustrating operation in updating an output virtual channel linked list to remove a data block;

FIG. 14 is a logic diagram illustrating operation in which both a read operation and a write operation are accomplished in a single read/write cycle; and

FIG. 15 is a state diagram illustrating operations in accordance with some operations of the present invention in managing receiver buffer contents.

### DETAILED DESCRIPTION OF THE INVENTION

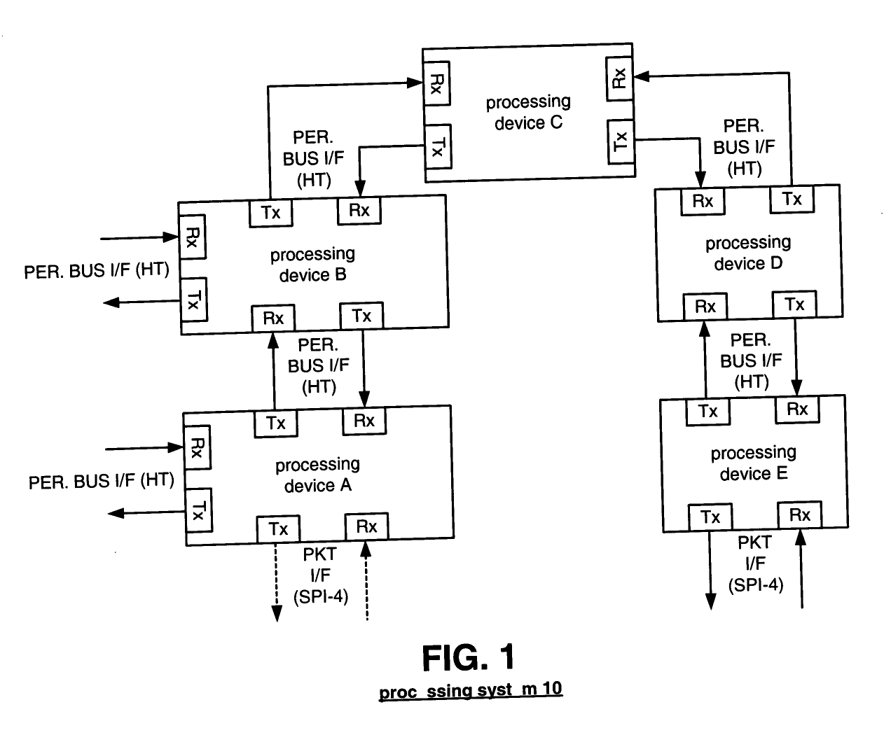

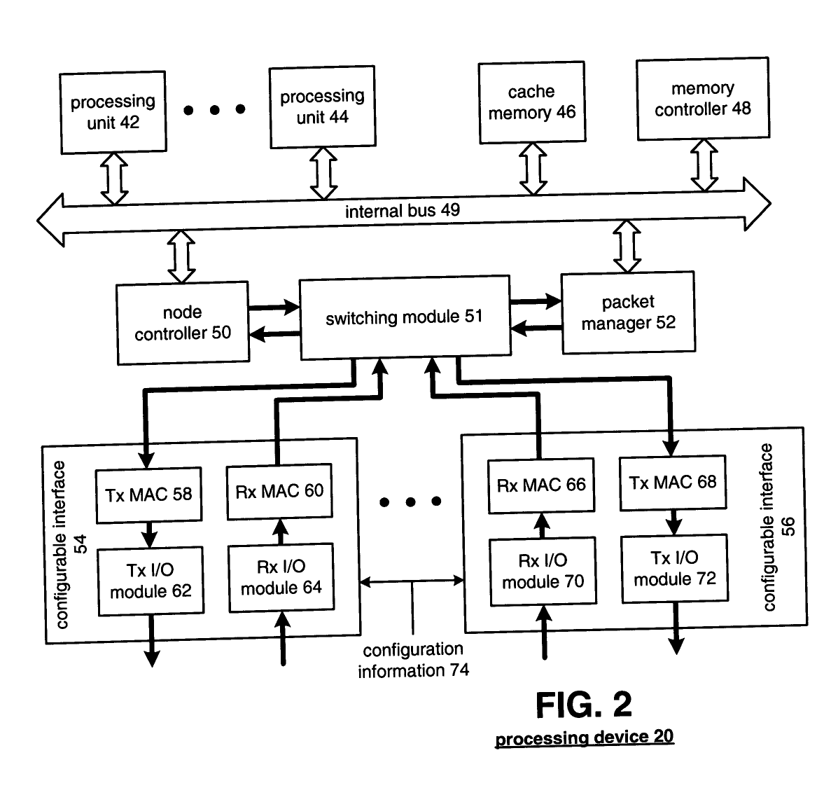

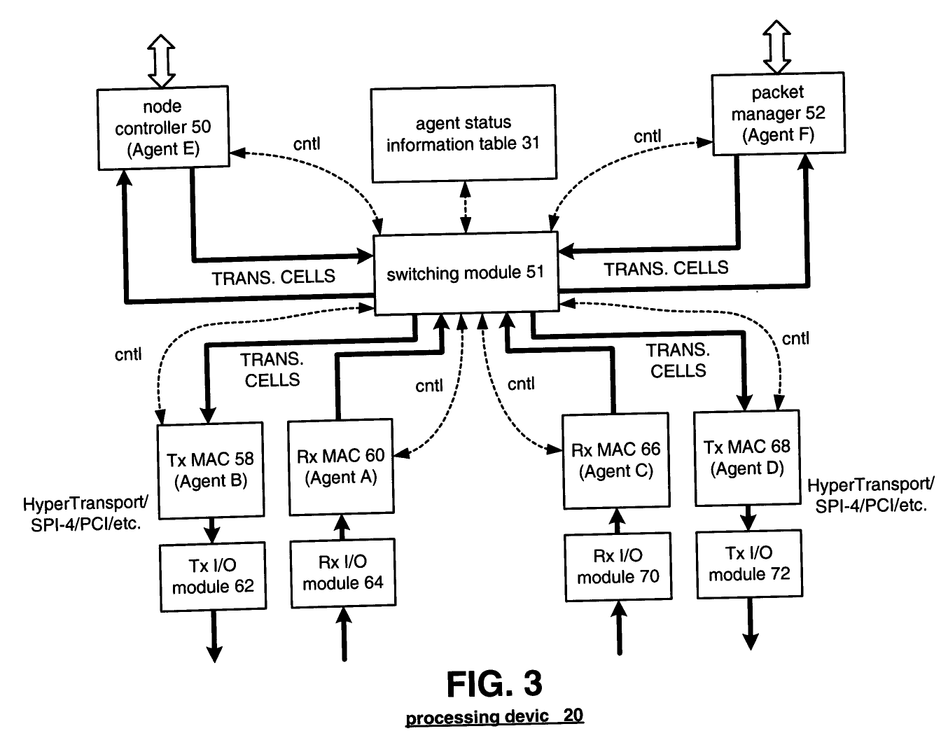

FIG. 1 is a schematic block diagram of a processing system 10 that includes a plurality of multiple processing devices A-E. Each of the multiple processing devices A-E includes one or more interfaces, each of which includes a Transmit (Tx) port and a Receive (Rx) port. The details of the multiple processing devices A-E will be described with reference to FIGS. 2 and 3. The processing devices A-E share resources in some operations. Such resource sharing may include the sharing of processing functions, the sharing of memory, and the sharing of other resources that the processing devices may perform or possess. The processing devices are coupled by a peripheral bus fabric, which may operate according to the HyperTransport (HT) standard. Thus, each processing device has at least two configurable interfaces, each having a transmit port and a receive port. In this fashion, the processing devices A-E may be coupled via a peripheral bus fabric to support resource sharing. Some of the devices may have more than two configurable interfaces to support coupling to more than two other devices. Further, the configurable interfaces may also support a packet-based interface, such as a SPI-4 interface, such as is shown in FIG. 1.

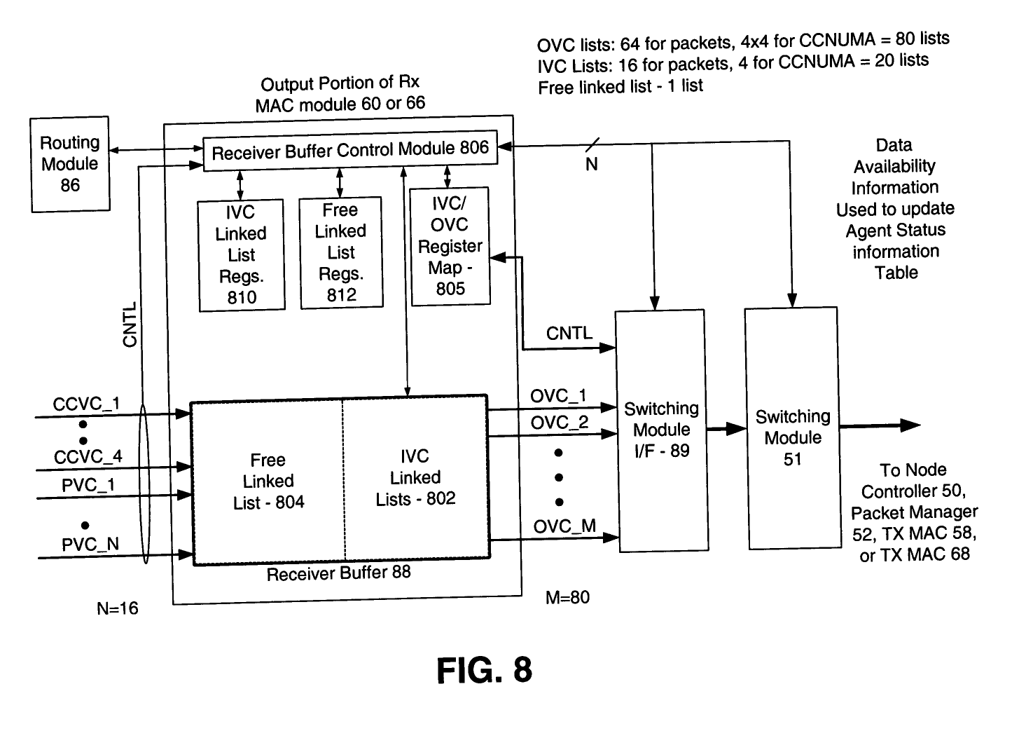

At least one of the processing devices A-E includes a received data processing storage system of the present invention. FIGS. 2-7 will describe generally the structure of a processing device and the manner in which communications between processing devices are serviced. FIGS. 8-15 will describe in detail the structure and operation of the received data processing storage system of the present invention.

FIG. 2 is a schematic block diagram of a multiple processing device 20 in accordance with the present invention. The multiple processing device 20 may be an integrated circuit or it may be constructed from discrete components. In either implementation, the multiple processing device 20 may be used as a processing device A-E in the processing system 10 illustrated in FIG. 1. The multiple processing device 20 includes a plurality of processing units 42-44, a cache memory 46, a memory controller 48, which interfaces with on and/or off-chip system memory, an internal bus 49, a node controller 50, a switching module 51, a packet manager 52, and a plurality of configurable packet based interfaces 54-56 (only two shown). The processing units 42-44, which may be two or more in numbers, may have a MIPS based architecture to support floating point processing and branch prediction. In addition, each processing unit 42-44 may include a memory sub-system of an instruction cache and a data cache and may support separately, or in combination, one or more processing functions. With respect to the processing system of FIG. 1, each processing unit 42-44 may be a destination within multiple processing device 20 and/or each processing function executed by the processing units 42-44 may be a destination within the multiple processing device 20.

The internal bus 49, which may be a 256-bit cache line wide split transaction cache coherent bus, couples the processing units 42-44, cache memory 46, memory controller 48, node controller 50 and packet manager 52, together. The cache memory 46 may function as an L2 cache for the processing units 42-44, node controller 50 and/or packet manager 52. With respect to the processing system of FIG. 1, the cache memory 46 may be a destination within multiple processing device 20.

The memory controller 48 provides an interface to system memory, which, when the multiple processing device 20 is an integrated circuit, may be off-chip and/or on-chip. With respect to the processing system of FIG. 1, the system memory may be a destination within the multiple processing device 20 and/or memory locations within the system memory may be individual destinations within the multiple processing device 20. Accordingly, the system memory may include one or more destinations for the processing systems illustrated in FIG. 1.

The node controller 50 functions as a bridge between the internal bus 49 and the configurable interfaces 54-56. Accordingly, accesses originated on either side of the node controller will be translated and sent on to the other. The node controller also supports the distributed shared memory model associated with the cache coherency non-uniform memory access (CC-NUMA) protocol.

The switching module 51 couples the plurality of configurable interfaces 54-56 to the node controller 50 and/or to the packet manager 52. The switching module 51 functions to direct data traffic, which may be in a generic format, between the node controller 50 and the configurable interfaces 54-56 and between the packet manager 52 and the configurable interfaces 54-56. The generic format, referred to herein as a “transaction cell,” may include 8-byte data words or 16-byte data words formatted in accordance with a proprietary protocol, in accordance with asynchronous transfer mode (ATM) cells, in accordance with Internet protocol (IP) packets, in accordance with transmission control protocol/Internet protocol (TCP/IP) packets, and/or in general, in accordance with any packet-switched protocol or circuit-switched protocol.

The packet manager 52 may be a direct memory access (DMA) engine that writes packets received from the switching module 51 into input queues of the system memory and reads packets from output queues of the system memory to the appropriate configurable interface 54-56. The packet manager 52 may include an input packet manager and an output packet manager each having its own DMA engine and associated cache memory. The cache memory may be arranged as first-in-first-out (FIFO) buffers that respectively support the input queues and output queues.

The configurable interfaces 54-56 generally function to convert data from a high-speed communication protocol (e.g., HT, SPI, etc.) utilized between multiple processing device 20 and the generic format of data within the multiple processing device 20. Accordingly, the configurable interface 54 or 56 may convert received HT or SPI packets into the generic format packets or data words for processing within the multiple processing device 20. In addition, the configurable interfaces 54 and/or 56 may convert the generic formatted data received from the switching module 51 into HT packets or SPI packets. The particular conversion of packets to generic formatted data performed by the configurable interfaces 54-56 is based on configuration information 74, which, for example, indicates configuration for HT to generic format conversion or SPI to generic format conversion.

Each of the configurable interfaces 54-56 includes a transmit media access control (Tx MAC) module 58 or 68, a receive (Rx) MAC module 60 or 66, a transmit input/output (I/O) module 62 or 72, and a receive input/output (I/O) module 64 or 70. In general, the Tx MAC module 58 or 68 functions to convert outbound data of a plurality of virtual channels in the generic format to a stream of data in the specific high-speed communication protocol (e.g., HT, SPI, etc.) format. The transmit I/O module 62 or 72 generally functions to drive the high-speed formatted stream of data onto the physical link coupling the present multiple processing device 20 to another multiple processing device. The transmit I/O module 62 or 72 is further described, and incorporated herein by reference, in co-pending patent application entitled, MULTI-FUNCTION INTERFACE AND APPLICATIONS THEREOF, having an attorney docket number of BP 2389 and a serial number of 10/305,648, and having been filed on Nov. 27, 2002. The Rx MAC module 60 or 66 generally functions to convert the received stream of data from the specific high-speed communication protocol (e.g., HT, SPI, etc.) format into data from a plurality of virtual channels having the generic format. The receive I/O module 64 or 70 generally functions to amplify and time align the high-speed formatted steam of data received via the physical link coupling the present multiple processing device 20 to another multiple processing device. The receive I/O module 64 or 70 is further described, and incorporated herein by reference, in co-pending patent application entitled, RECEIVER MULTI-PROTOCOL INTERFACE AND APPLICATIONS THEREOF, having an attorney docket number of BP 2389.1 and a serial number of 10/305,558, and having been filed on Nov. 27, 2002.

The transmit and/or receive MAC modules 58, 60, 66 and/or 68 may include, individually or in combination, a processing module and associated memory to perform its corresponding functions. The processing module may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the processing module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. The memory stores, and the processing module executes, operational instructions corresponding to the functionality performed by the Tx MAC module 58 or 68 as disclosed, and incorporated herein by reference, in the co-pending parent patent application entitled, TRANSMITTING DATA FROM A PLURALITY OF VIRTUAL CHANNELS VIA A MULTIPLE PROCESSOR DEVICE, having an attorney docket number of BP 2184.1 and serial number of 10/356,348, and having been filed on Jan. 31, 2003.

In operation, the configurable interfaces 54-56 provide the means for communicating with other multiple processing devices 20 in a processing system such as the ones illustrated in FIG. 1. The communication between multiple processing device 20 via the configurable interfaces 54 and 56 is formatted in accordance with a particular high-speed communication protocol (e.g., HyperTransport (HT) or system packet interface (SPI)). The configurable interfaces 54-56 may be configured to support, at a given time, one or more of the particular high-speed communication protocols. In addition, the configurable interfaces 54-56 may be configured to support the multiple processing device 20 in providing a tunnel function, a bridge function, or a tunnel-bridge hybrid function.

The configurable interface 54 or 56 receives high-speed communication protocol formatted stream of data and separates, via the Rx MAC module 60 or 66, the stream of incoming data into generic formatted data associated with one or more of a plurality of particular virtual channels. The particular virtual channel may be associated with a local module of the multiple processing device 20 (e.g., one or more of the processing units 42-44, the cache memory 46 and/or the memory controller 48) and, accordingly, corresponds to a destination of the multiple processing device 20, or the particular virtual channel may be for forwarding packets to another multiple processing device.

The configurable interface 54 or 56 provides the generically formatted data words, which may comprise a packet, or portion thereof, to the switching module 51, which routes the generically formatted data words to the packet manager 52 and/or to node controller 50. The node controller 50, the packet manager 52, and/or one or more processing units 42-44 interprets the generically formatted data words to determine a destination therefor. If the destination is local to multiple processing device 20 (i.e., the data is for one of processing units 42-44, cache memory 46 or memory controller 48), the node controller 50 and/or packet manager 52 provides the data, in a packet format, to the appropriate destination. If the data is not addressing a local destination, the packet manager 52, node controller 50 and/or processing units 42-44 causes the switching module 51 to provide the packet to one of the other configurable interfaces 54 or 56 for forwarding to another multiple processor device in the processing system. For example, if the data were received via configurable interface 54, the switching module 51 would provide the outgoing data to configurable interface 56. In addition, the switching module 51 provides outgoing packets generated by the local modules of multiple processing device 20 to one or more of the configurable interfaces 54-56.

The configurable interface 54 or 56 receives the generic formatted data via the Tx MAC module 58 or 68. The Tx MAC module 58 or 68 converts the generic formatted data from a plurality of virtual channels into a single stream of data. The transmit I/O module 62 or 72 drives the stream of data on to the physical link coupling the present multiple processing device to another.

To determine the destination of received data, the node controller 50, the packet manager 52, and/or one of the processing units 42 or 44 interprets header information of the data to identify the destination (i.e., determines whether the target address is local to the device). In addition, a set of ordering rules of the received data is applied when processing the data, where processing includes forwarding the data, in packets, to the appropriate local destination or forwarding it onto another device. The ordering rules include the HT specification ordering rules and rules regarding non-posted commands being issued in order of reception. The rules further include that the interfaces are aware of whether they are configured to support a tunnel, bridge, or tunnel-bridge hybrid node. With such awareness, for every ordered pair of transactions, the receiver portion of the interface will not make a new transaction of an ordered pair visible to the switching module until the old transaction of an ordered pair has been sent to the switching module. The node controller, in addition to adhering to the HT specified ordering rules, treats all HT transactions as being part of the same input/output stream, regardless of which interface the transactions were received from. Accordingly, by applying the appropriate ordering rules, the routing to and from the appropriate destinations either locally or remotely is accurately achieved.

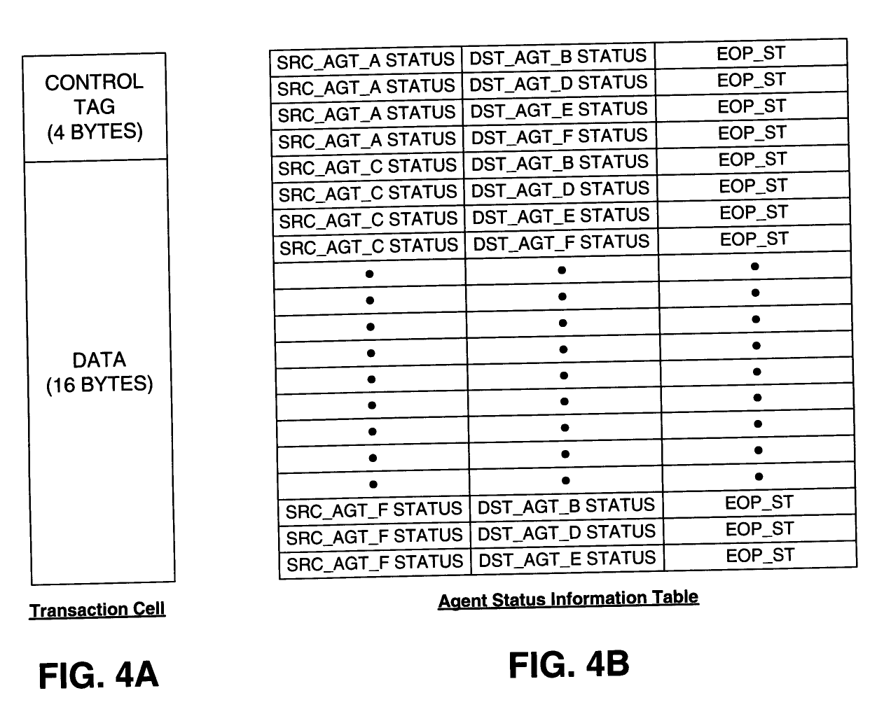

FIG. 3 is a schematic block diagram of the multiple processor device of FIG. 2 illustrating the flow of transaction cells between components thereof in accordance with the present invention. The components of FIG. 3 are common to the components of FIG. 2 and will not be described further herein with respect to FIG. 3 except as to describe aspects of the present invention. Each component of the configurable interface, e.g., Tx MAC module 58, Rx MAC module 60, Rx MAC module 66, and Tx MAC module 68, is referred to as an agent within the processing device 20. Further, the node controller 50 and the packet manager 52 are also referred to as agents within the processing device 20. The agents A-F intercouple via the switching module 51. Data routed between the agents via the switching module 51 is carried within transaction cells, which will be described further with respect to FIGS. 4A and 4B. The switching module 51 maintains an agent status information table 31, which will be described further with reference to FIG. 4B.

The switching module 51 interfaces with the agents A-F via control information to determine the availability of data for transfer and resources for receipt of data by the agents. For example, in one operation an Rx MAC module 60 (Agent A) has data to transfer to packet manager 52 (Agent F). The data is organized in the form of transaction cells, as shown in FIG. 4A. When the Rx MAC module 60 (Agent A) has enough data to form a transaction cell corresponding to a particular output virtual channel that is intended for the packet manager 52 (Agent F), the control information between Rx MAC module 60 (Agent A) and switching module 51 causes the switching module 51 to make an entry in the agent status information table 31 indicating the presence of such data for the output virtual channel (referred to herein interchangeably as “switch virtual channel”). The packet manager 52 (Agent F) indicates to the switching module 51 that it has input resources that could store the transaction cell of the output virtual channel currently stored at Rx MAC module 60 (Agent A). The switching module 51 updates the agent status information table 31 accordingly.

When a resource match occurs that is recognized by the switching module 51, the switching module 51 schedules the transfer of the transaction cell from Rx MAC module 60 (Agent A) to packet manager 52 (Agent F). The transaction cells are of a common format independent of the type of data they carry. For example, the transaction cells can carry packets or portions of packets, input/output transaction data, cache coherency information, and other types of data. The transaction cell format is common to each of these types of data transfer and allows the switching module 51 to efficiently service any type of transaction using a common data format.

Referring now to FIG. 4A, each transaction cell includes a transaction cell control tag and transaction cell data. In the embodiment illustrated in FIG. 4A, the transaction cell control tag is 4 bytes in size, whereas the transaction cell data is 16 bytes in size. Referring now to FIG. 4B, the agent status information table has an entry for each pair of source agent devices and destination agent devices, as well as control information indicating an end of packet (EOP) status. When a packet transaction is fully or partially contained in a transaction cell, that transaction cell may include an end of packet indicator. In such case, the source agent communicates via the control information with the switching module 51 to indicate that it has a transaction cell ready for transfer and that the transaction cell has contained therein an end of packet indication. Such indication would indicate that the transaction cell carries all or a portion of a packet. When it carries a portion of a packet, the transaction cell carries a last portion of the packet, including the end of packet.

The destination agent status contained within a particular record of the agent status information table 31 indicates the availability of resources in the particular destination agent to receive a transaction cell from a particular source agent. When a match occurs, in that a source agent has a transaction cell ready for transfer and the destination agent has resources to receive the transaction cell from the particular source agent, then a match occurs in the agent status information table 31 and the switching module 51 transfers the transaction cell from the source agent to the destination agent. After this transfer, the switching module 51 will change the status of the corresponding record of the agent status information table to indicate the transaction has been completed. No further transaction will be serviced between the particular source agent and the destination agent until the corresponding source agent has a transaction cell ready to transfer to the destination agent, at which time the switching module 51 will change the status of the particular record in the agent status information table to indicate the availability of the transaction cell for transfer. Likewise, when the destination agent has the availability to receive a transaction cell from the corresponding source agent, it will communicate with the switching module 51 to change the status of the corresponding record of the agent status information table 31.

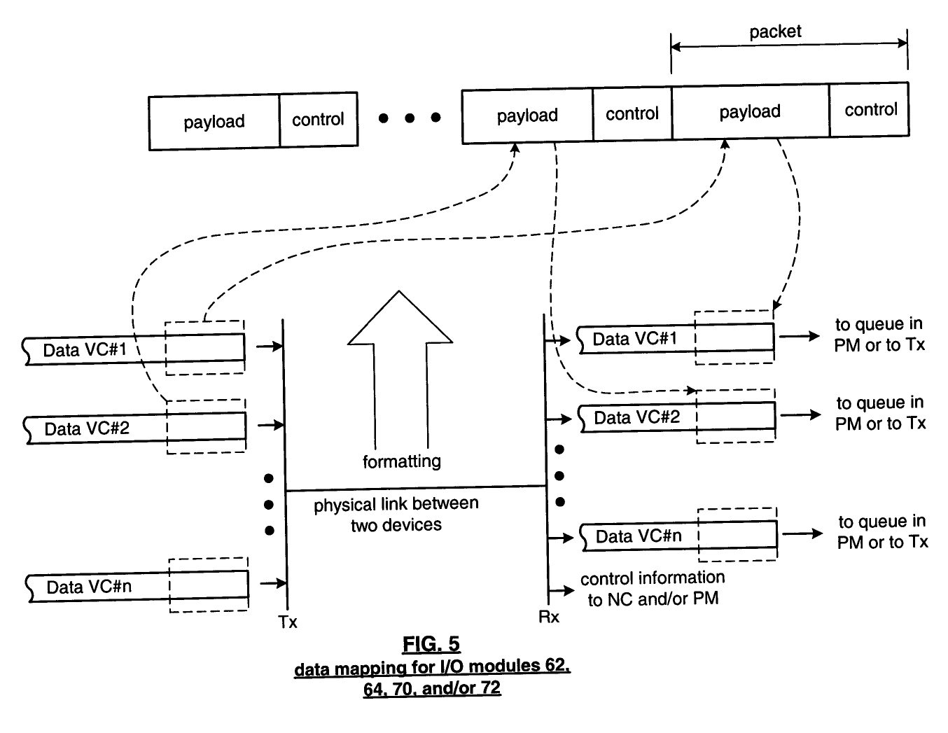

FIG. 5 is a graphical representation of the functionality performed by the node controller 50, the switching module 51, the packet manager 52 and/or the configurable interfaces 54-56. In this illustration, data is transmitted over a physical link between two devices in accordance with a particular high-speed communication protocol (e.g., HT, SPI-4, etc.). Accordingly, the physical link supports a protocol that includes a plurality of packets. Each packet includes a data payload and a control section. The control section may include header information regarding the payload, control data for processing the corresponding payload of a current packet, previous packet(s) or subsequent packet(s), and/or control data for system administration functions.

Within a multiple processing device, a plurality of virtual channels may be established. A virtual channel may correspond to a particular physical entity, such as processing units 42-44, cache memory 46 and/or memory controller 48, and/or to a logical entity such as a particular algorithm being executed by one or more of the processing units 42-44, particular memory locations within cache memory 46 and/or particular memory locations within system memory accessible via the memory controller 48. In addition, one or more virtual channels may correspond to data packets received from downstream or upstream nodes that require forwarding. Accordingly, each multiple processor device supports a plurality of virtual channels. The data of the virtual channels, which is illustrated as data virtual channel #1 (VC#1), data virtual channel #2 (VC#2) through data virtual channel #n (VC#n) may have a generic format. The generic format may be 8-byte data words or 16-byte data words that correspond to a proprietary protocol, ATM cells, IP packets, TCP/IP packets, other packet switched protocols and/or circuit switched protocols.

As illustrated, a plurality of virtual channels is sharing the physical link between the two devices. The multiple processing device 20, via one or more of the processing units 42-44, the node controller 50, the configurable interfaces 54-56, and/or the packet manager 52 manages the allocation of the physical link among the plurality of virtual channels. As shown, the payload of a particular packet may be loaded with one or more segments from one or more virtual channels. In this illustration, the first packet includes a segment, or fragment, of data virtual channel #1. The data payload of the next packet receives a segment, or fragment, of data virtual channel #2. The allocation of the bandwidth of the physical link to the plurality of virtual channels may be done in a round-robin fashion, a weighted round-robin fashion or some other application of fairness. The data transmitted across the physical link may be in a serial format and at extremely high data rates (e.g., 3.125 gigabits-per-second or greater), in a parallel format, or a combination thereof (e.g., 4 lines of 3.125 Gbps serial data).

At the receiving device, the stream of data is received and then separated into the corresponding virtual channels via one of the configurable interfaces 54-56, the switching module 51, the node controller 50, and/or the packet manager 52. The recaptured virtual channel data is either provided to an input queue for a local destination or provided to an output queue for forwarding via one of the configurable interfaces to another device. Accordingly, each of the devices in a processing system as illustrated in FIGS. 1-3 may utilize a high-speed serial interface, a parallel interface, or a plurality of high-speed serial interfaces, to transceive data from a plurality of virtual channels utilizing one or more communication protocols and be configured in one or more configurations while substantially overcoming the bandwidth limitations, latency limitations, limited concurrency (i.e., renaming of packets) and other limitations associated with the use of a high-speed HyperTransport chain. Configuring the multiple processor devices for application in the multiple configurations of processing systems is described in greater detail, and incorporated herein by reference, in co-pending patent application entitled, MULTIPLE PROCESSOR INTEGRATED CIRCUIT HAVING CONFIGURABLE INTERFACES, having an attorney docket number of BP 2186 a serial number of 10/356,390, and having been filed on Jan. 31, 2003.

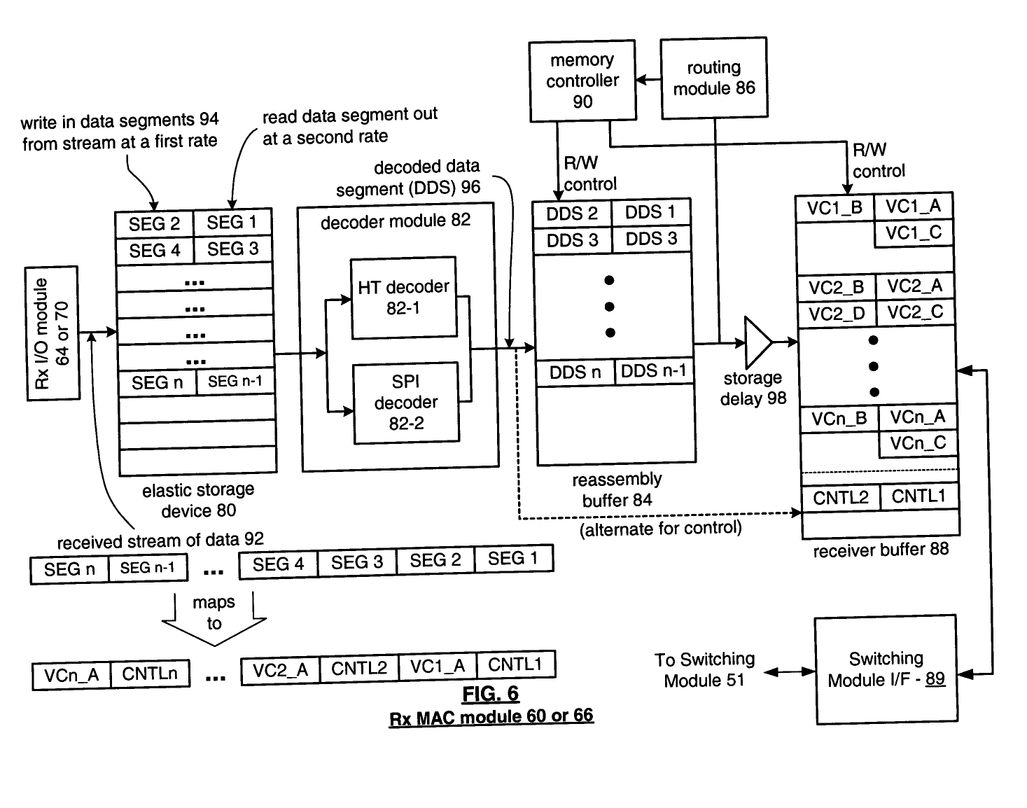

FIG. 6 is a schematic block diagram of a portion of a Rx MAC module 60 or 66. The Rx MAC module 60 or 66 includes an elastic storage device 80, a decoder module 82, a reassembly buffer 84, a storage delay element 98, a receiver buffer 88, a routing module 86, and a memory controller 90. The decoder module 82 may include a HyperTransport (HT) decoder 82-1 and a system packet interface (SPI) decoder 82-2.

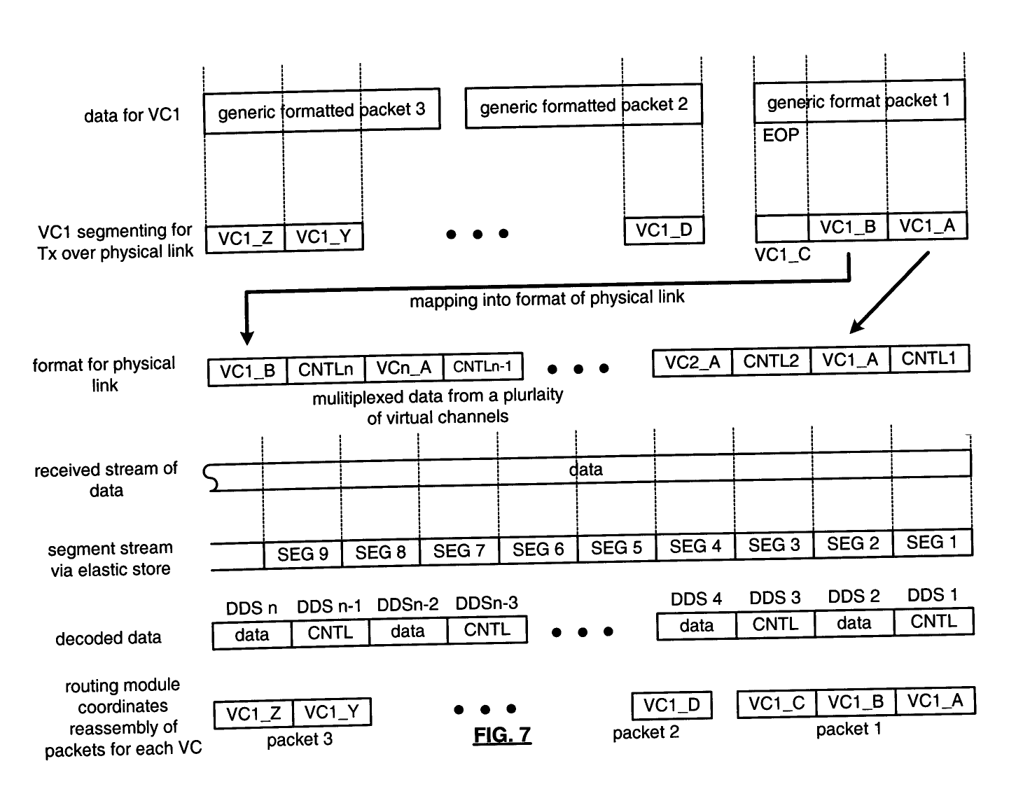

The elastic storage device 80 is operably coupled to receive a stream of data 92 from the receive I/O module 64 or 70. The received stream of data 92 includes a plurality of data segments (e.g., SEG1-SEG n). The data segments within the stream of data 92 correspond to control information and/or data from a plurality of virtual channels. The particular mapping of control information and data from virtual channels to produce the stream of data 92 will be discussed in greater detail with reference to FIG. 7. The elastic storage device 80, which may be a dual port SRAM, DRAM memory, register file set, or other type of memory device, stores the data segments 94 from the stream at a first data rate. For example, the data may be written into the elastic storage device 80 at a rate of 64 bits at a 400 MHz rate. The decoder module 82 reads the data segments 94 out of the elastic storage device 80 at a second data rate in predetermined data segment sizes (e.g., 8 or 16-byte segments).

The stream of data 92 is partitioned into segments for storage in the elastic storage device 80. The decoder module 82, upon retrieving data segments from the elastic storage device 80, decodes the data segments to produce decoded data segments (DDS) 96. The decoding may be done in accordance with the HyperTransport protocol via the HT decoder 82-1 or in accordance with the SPI protocol via the SPI decoder 82-2. Accordingly, the decoder module 82 is taking the segments of binary encoded data and decodes the data to begin the reassembly process of recapturing the originally transmitted data packets.

The reassembly buffer 84 stores the decoded data segments 96 in a first-in-first-out manner. In addition, if the corresponding decoded data segment 96 is less than the data path segment size (e.g., 8 bytes, 16 bytes, etc.), the reassembly buffer 84 pads the decoded data segment 96 with the data path segment size. In other words, if, for example, the data path segment size is 8 bytes and the particular decoded data segment 96 is 6 bytes, the reassembly buffer 84 will pad the decoded data segment 96 with 2 bytes of null information such that it is the same size as the corresponding data path segment. Further, the reassembly buffer 84 aligns the data segments to correspond with desired word boundaries. For example, assume that the desired word includes 16 bytes of information and the boundaries are byte 0 and byte 15. However, in a given time frame, the bytes that are received correspond to bytes 14 and 15 from one word and bytes 0-13 of another word. In the next time frame, the remaining two bytes (i.e., 14 and 15) are received along with the first 14 bytes of the next word. The reassembly buffer 84 aligns the received data segments such that full words are received in the given time frames (i.e., receive bytes 0-15 of the same word as opposed to bytes from two different words). Still further, the reassembly buffer 84 buffers the decoded data segments 96 to overcome inefficiencies in converting high-speed minimal bit data to slower-speed multiple bit data. Such functionality of the reassembly buffer ensures that the reassembly of data packets will be accurate.

The decoder module 82 may treat control information and data from virtual channels alike or differently. When the decoder module 82 treats the control information and data of the virtual channels similarly, the decoded data segments 96, which may include a portion of data from a virtual channel or control information, is stored in the reassembly buffer 84 in a first-in-first-out manner. Alternatively, the decoder module 82 may detect control information separately and provide the control information to the receiver buffer 88 thus bypassing the reassembly buffer 84. In this alternative embodiment, the decoder module 82 provides the data of the virtual channels to the reassembly buffer 84 and the control information to the receiver buffer 88.

The routing module 86 interprets the decoded data segments 96 as they are retrieved from the reassembly buffer 84. The routing module 86 interprets the data segments to determine which virtual channel they are associated with and/or for which piece of control information they are associated with. The resulting interpretation is provided to the memory controller 90, which, via read/write controls, causes the decoded data segments 96 to be stored in a location of the receiver buffer 88 allocated for the particular virtual channel or control information. The storage delay element 98 compensates for the processing time of the routing module 86 to determine the appropriate storage location within the receiver buffer 88.

The receiver buffer 88 may be a static random access memory (SRAM) or dynamic random access memory (DRAM) and may include one or more memory devices. In particular, the receiver buffer 88 may include a separate memory device for storing control information and a separate memory device for storing information from the virtual channels. Once at least a portion of a packet of a particular virtual channel is stored in the receiver buffer 88, it may be routed to an input queue in the packet manager or routed to an output queue for routing, via another configurable interface 54 or 56, as an upstream packet or a downstream packet to another multiple processor device.

FIG. 6 further illustrates an example of the processing performed by the Rx MAC module 60 or 66. In the example, data segment 1 of the received stream of data 92 corresponds with control information CNTL 1. The elastic storage device 80 stores data segment 1, which, with respect to the Rx MAC module 60 or 66, is a set number of bytes of data (e.g., 8 bytes, 16 bytes, etc.). The decoder module 82 decodes data segment 1 to determine that data segment 1 corresponds to control information. The decoded data segment is then stored in the reassembly buffer 84 or provided to the receiver buffer 88. If the decoded control information segment is provided to the reassembly buffer 84, it is stored in a first-in-first-out manner. At some later time, the decoded control information segment is read from the reassembly buffer 84 by the routing module 86 and interpreted to determine that it is control information associated with a particular packet or particular control function. Based on this interpretation, the decoded data segment 1 is stored in a particular location of the receiver buffer 88.

Continuing with the example, the second data segment (SEG 2) corresponds to a first portion of data transmitted by virtual channel #1. This data is stored as binary information in the elastic storage device 80 as a fixed number of binary bits (e.g., 8 bytes, 16 bytes, etc.). The decoder module 82 decodes the binary bits to produce the decoded data segments 96, which, for this example, corresponds to DDS 2. When the decoded data segment (DDS 2) is read from the reassembly buffer 84, the routing module 86 interprets it to determine that it corresponds to a packet transmitted from virtual channel #1. Based on this interpretation, the portion of receiver buffer 88 corresponding to virtual channel #1 will be addressed via the memory controller 90 such that the decoded data segment #2 will be stored, as VC1_A in the receiver buffer 88. The remaining data segments illustrated in FIG. 6 are processed in a similar manner. Accordingly, by the time the data is stored in the receiver buffer 88, the stream of data 92 is decoded and segregated into control information and data information, where the data information is further segregated based on the virtual channels that transmitted it. As such, when the data is retrieved from the receiver buffer 88, it is in a generic format and partitioned based on the particular virtual channels that transmitted it.

Still referring to FIG. 6, a switching module interface 89 interfaces with the receiver buffer 88 and couples to the switching module 51. The receiver buffer 88 stores data on the basis of input virtual channels and/or output virtual channels. Output virtual channels are also referred to herein as switch virtual channels. The receiver buffer 88 may only transmit data to the switching module 51 via the switching module interface 89 on the basis of output virtual channels. Thus, the agent status information table 31 is not updated to indicate the availability of output data until the receiver buffer 88 data is in the format of an output virtual channel and the data may be placed into a transaction cell for transfer to the switching module 51 via the switching module interface 89. The switching module interface 89 exchanges both data and control information with the switching module 51. In such case, the switching module 51 directs the switching module interface 89 to output transaction cells to the switching module. The switching module interface 89 extracts data from the receiver buffer 88 and forms the data into transaction cells that are transferred to the switching module 51.

The Tx MAC module 58 or 68 will have an equivalent, but inverted structure for the receipt of transaction cells from the switching module 51. In such case, a switching module interface of the Tx MAC module 58 or 68 will receive transaction cells from the switching module 51. Further, the switching module interfaces of the Tx MAC modules 58 and 68 will communicate control information to and from the switching module 51 to support the transfer of transaction cells.

FIG. 7 is a graphical representation of the function of the Tx MAC module 58 or 68 and the Rx MAC module 60 or 66. The Tx MAC module 58 or 68 receives packets from a plurality of virtual channels via the switching module 51. FIG. 7 illustrates the packets received by the Tx MAC module 58 or 68 from a first virtual channel (VC1). The data is shown in a generic format, which may correspond to ATM cells, frame relay packets, IP packets, TCP/IP packets, other types of packet switched formatting, and/or circuit switched formatting. The Tx MAC module 58 or 68 partitions the generically formatted packets into a plurality of data segments of a particular size. For example, the first data packet of virtual channel 1 is partitioned into three segments, VC1_A, VC1_B and VC1_C. The particular size of the data segments corresponds with the desired data path size, which may be 8 bytes, 16 bytes, etc.

The first data segment for packet 1 (VC1_A) will include a start-of-packet indication or packet 1. The third data segment of packet 1 (VC1_C) will include an end-of-packet indication for packet 1. Since VC1_C corresponds to the last data segment of packet 1, it may be of a size less than the desired data segment size (e.g., of 8 bytes, 16 bytes, etc.). When this is the case, the data segment VC1_C will be padded and/or aligned via the reassembly buffer to be of the desired data segment size and aligned along word boundaries. Further note that each of the data segments may be referred to as data fragments. The segmenting of packets continues for the data produced via virtual channel 1 as shown. The Tx MAC module 58 or 68 then maps the data segments from the plurality of control virtual channels and control information into a particular format for transmission via the physical link. As shown, the data segments for virtual channel 1 are mapped into the format of the physical link, which provides a multiplexing of data segments from the plurality of virtual channels along with control information.

At the receiver side of the configurable interface 54 or 56, the transmitted data is received as a stream of data. As stated with respect to FIG. 6, the receiver section segments the stream of data and stores it via an elastic storage device. The decoder decodes the segments to determine control and data information. Based on the decoded information, the routing module coordinates the reassembly of the packets for each of the virtual channels. As shown, the resulting data stored in the receiver buffer includes the data segments corresponding to packet 1, the data segments corresponding to packet 2, and the data segments corresponding to packet 3 for virtual channel 1.

FIG. 8 is a block diagram illustrating a first embodiment of an output portion of the Rx MAC module 60 or 66 illustrating a first receiver buffer organization structure. The nomenclature used in FIG. 8 corresponds mostly with that of FIGS. 2 and 3, but includes additional structure to more fully describe the received data processing storage system of an embodiment in the present invention. The receiver buffer 88, also shown in FIG. 6, receives data blocks from the reassembly buffer 84 via the storage delay element 98 on the basis of virtual channels. As was described in FIGS. 5-7, the virtual channels may include cache coherency virtual channels, packet virtual channels, and also virtual channels corresponding to input/output transactions.

The virtual channels in which the receiver buffer 88 receives data blocks are referred to hereinafter as “input virtual channels” (IVCs). IVCs illustrated in FIG. 8 include four Cache Coherency Virtual Channels (CCVC) inputs and N Packet Virtual Channel (PVC) inputs, where N is equal to 16. In such case, in the example of FIG. 8, there are 20 IVCs incoming to the receiver buffer 88. In other embodiments, the receiver buffer 88 may service input/output type transactions on a non-virtual channel basis. The output portion of the Rx MAC module 60 or 66 outputs data blocks in the form of transaction cells to the switching module 51. The transaction cells contain data blocks corresponding to “output virtual channels” (OVCs) also referred to hereinafter interchangeably as “switch virtual channels.” In one embodiment, there are 80 output virtual channels-64 for packet-type communications and 16 for cache coherency-type operations. This particular example is directed to one embodiment of a processing device 20 of the present invention and the number of IVCs and OVCs varies from embodiment to embodiment.

The output portion of the Rx MAC module 60 or 66 includes the receiver buffer 88, which is organized into input virtual channel linked lists (IVC linked lists) 802 and a free linked list 804. The output portion of the Rx MAC module 60 or 66 also includes a receiver buffer control module 806, IVC linked list registers 810, free linked list registers 812, and an IVC/OVC register map 805. The IVC linked list registers 810 and the free linked list registers 812 each include head registers and tail registers for each supported IVC. The receiver buffer control module 806 communicatively couples to the routing module 86 to receive routing information from the routing module 86, couples to the switching module 51 to exchange control information with the switching module 51, and couples to the switching module interface (I/F) 89 to exchange information therewith. The interaction between the receiver buffer control module 806 and the routing module 86 allows the receiver buffer control module 806 to map incoming data blocks to IVCs (CCVCs and PVCs), to map the IVCs to OVCs, and to store the IVC/OVC mapping in the IVC/OVC register map 805. Mapping of incoming data to IVCs and mapping IVCs to OVCs is performed based upon header information, protocol information, source identifier/address information, and destination identifier/address information, among other information extracted from the incoming data blocks.

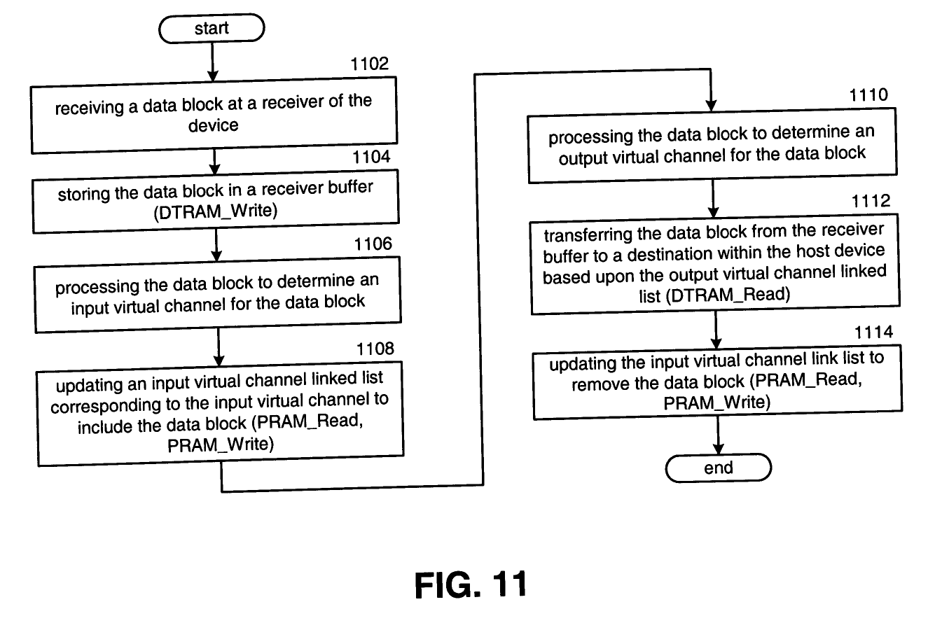

In the particular system of FIG. 8, an input receives the data blocks. The receiver buffer 88 is operable to instantiate an IVC linked list 800 for storing data blocks on an IVC basis and to instantiate a free list 802 that includes free data locations. The data blocks referred to with reference to FIG. 8 and the subsequent figures correspond to all or a portion of the transaction cell of FIG. 4A. Typically, the data blocks described with reference to FIG. 8 take a different form than the transaction cells, with the transaction cells including the data blocks plus additional control information relating to the data blocks being carried. The switching module I/F 89 of the Rx MAC module 60 or 66 operably couples to the receiver buffer control module 806, the receiver buffer 88, and the switching module 51. The switching module I/F 89 receives the data blocks on the basis of OVCs and formats the data blocks into transaction cells for forwarding to the switching module 51. The operations of the received data processing storage system of FIG. 8 will be described in detail with reference to FIG. 11.

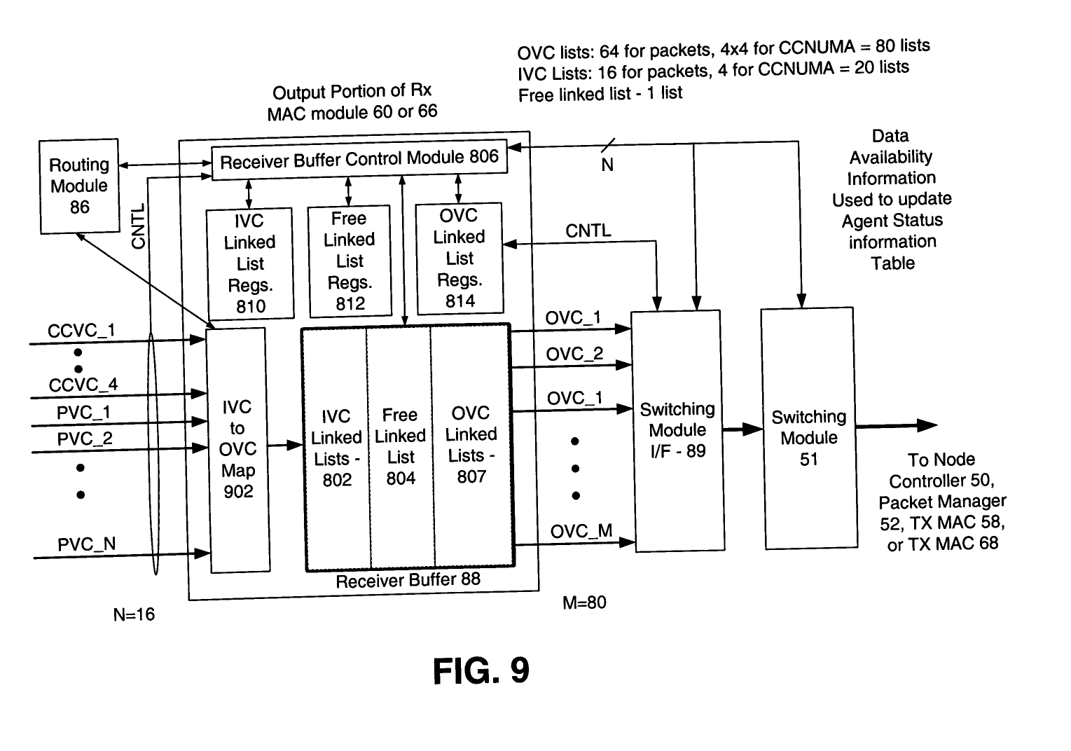

Referring now to FIG. 9, an output portion of the Rx MAC module 60 or 66 in an alternate embodiment is described. Elements that share common numbering with the elements of FIG. 8 include same or similar structure and operation. As contrasted to the structure of FIG. 8, the structure of FIG. 9 includes an IVC to OVC map 902 and OVC linked list registers 814 but does not include the IVC/OVC Register Map 805. Further, the receiver buffer 88 instantiates OVC linked lists 807. The IVC to OVC map 902 operably couples to the routing module 86 and, if available, has a current mapping of IVCs to OVCs. Data blocks that is incoming to the IVC to OVC map 902 are received on IVCs and are mapped to corresponding OVCs. However, not all incoming data blocks will have associated therewith an OVC, particularly if they form a first portion of a long data packet or other multiple data block transaction. In such case, incoming data blocks that do not have an associated OVC are placed into corresponding IVC linked lists. Those data blocks incoming that have associated therewith an OVC will be processed by the IVC to OVC map 902 and placed directly into OVC linked lists 807. When an OVC is identified for the data blocks that have been stored on an IVC basis, the receiver buffer control module 806 will remove the data blocks from an IVC linked list in which they were stored and include the data blocks into a corresponding OVC. The IVC linked list registers 810, the free linked list registers 812, and the OVC linked list registers 814 each include head registers and tail registers for each supported linked list.

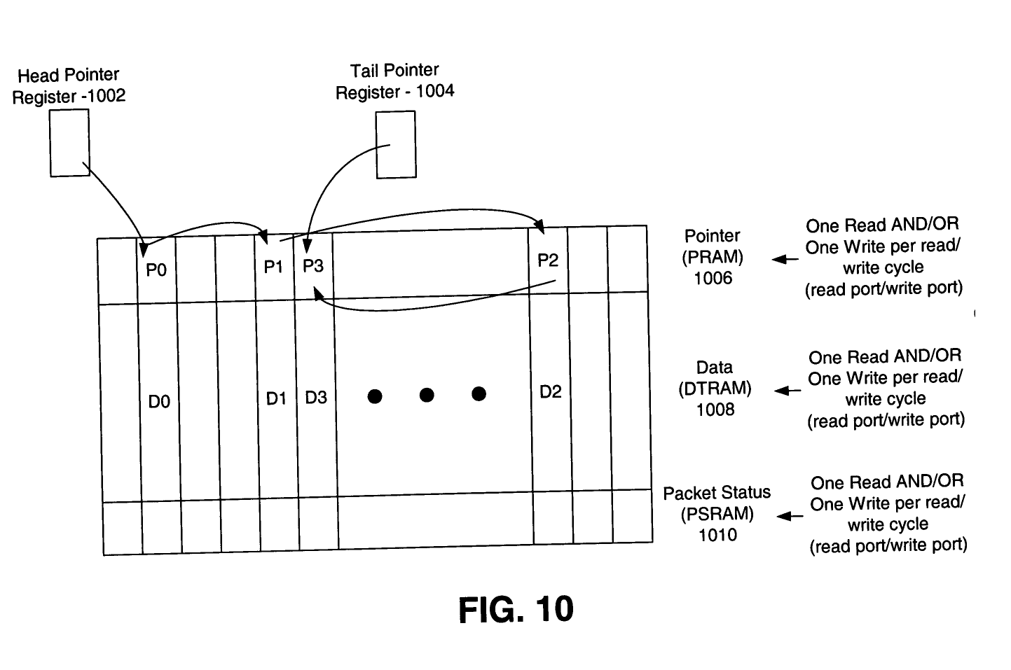

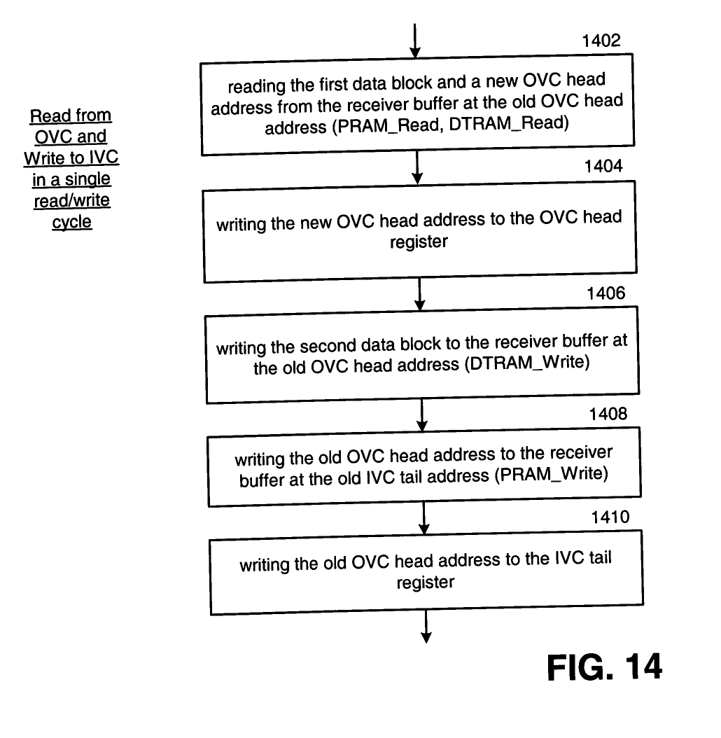

FIG. 10 is a block diagram illustrating the structure of a linked list in accordance with the present invention. Referring now to FIG. 10, the structure of the receiver buffer 88 and the linked list contained therein is shown. The receiver buffer 88 is structured with a pointer memory (PRAM) 1006, a data memory (DTRAM) 1008, and a packet status memory (ERAM) 1010. With the structure of the receiver buffer 88, a single address will address corresponding locations of the PRAM 1006, the DTRAM 1008, and the ERAM 1010. According to one further aspect of the present invention, the receiver buffer 88 may be accessed via a pointer memory read port, a pointer memory write port, a data memory read port, a data memory write port, a packet status memory read port, and an end-of-packet write port. Thus, in a single read/write cycle, each portion of memory PRAM 1006, DTRAM 1008, and ERAM 1010, may be written to and read from, or read from and written to, in a single read/write cycle. This particular aspect of the present invention allows for a streamlined and efficient management of the receiver buffer 88 to process incoming data blocks and outgoing data blocks. The benefits of the paired read and write ports will be described in detail with the operations of FIG. 14.

To manage any linked list, the address of the linked list head and linked list tail must be recorded. Thus, the IVC linked list registers 810 include a head pointer register to store the IVC linked list head pointer and a tail pointer register to store the IVC linked list tail pointer. The OVC linked list registers 812 include a head pointer register to store the OVC linked list head pointer and a tail pointer register to store the OVC linked list tail pointer. Likewise, the free linked list registers 814 include a head pointer register to store the free linked list head pointer and a tail pointer register to store the free linked list tail pointer. The generic linked list of FIG. 10 shows the relationship of the head pointer register contents to the memory locations making up the particular linked list. As shown, an address stored in a head pointer register 1002 points to the head of the linked list while an address stored in a tail pointer register 1004 points to the tail of the linked list. Each location of PRAM 1006 in the linked list, beginning with the head, points to the next location in the linked list. PRAM 1006 at the linked list tail pointer address does not point to a linked location. However, when the linked list is written, the PRAM 1006 at the old tail address will be updated to point to the new linked list tail.

FIG. 11 is a logic diagram illustrating a first embodiment of a method for processing incoming data blocks in accordance with the present invention. The operations of FIG. 11 begin when the receiver of a host device receives a data block. The data block is received at an input (step 1102). Operation continues with the receiver buffer storing the data block via a DTRAM_Write (step 1104). The data block typically forms a portion of a transmission, e.g., data packet, I/O transaction, cache-coherency transaction, etc. It may be explicitly associated with an IVC, or it may not. Thus, the method includes processing the data block, in conjunction with other data blocks in many cases, to determine an input virtual channel for the data block (step 1106). With the IVC determined, the corresponding IVC linked list is modified to include the data block (step 1108). Updating the IVC linked list to include the data block requires both a PRAM_Read and a PRAM_Write.

The data block is processed in parallel and/or in sequence with other operations of FIG. 11 to determine an OVC for the data block (step 1110). The routing module 86 of FIGS. 6, 8, and 9 performs such processing. For packet data transactions, a number of data blocks containing portions of a particular packet are typically required to determine an OVC. After the routing module 86 determines an OVC for the data block, the IVC/OVC register map 805 is updated to reflect this relationship. In a typical implementation the IVC/OVC register map 805 identifies an OVC for each IVC and whether the relationship is currently valid.

When the switching module has determined that a source agent, in this case the Rx MAC module 60 or 66, has a transaction cell available for transfer and a destination agent can receive the transaction cell, the switching module 51 initiates the transfer of one or more data blocks to a destination agent within a transaction cell, the output packaging the data block(s) into a transaction cell. The switching module I/F 89 creates a transaction cell that includes the data block and interfaces with the switching module 51 to transfer the data block within a transaction cell from the receiver buffer 88 to a destination within the host device based upon the OVC identified in the IVC/OVC register map 805 (step 1112) using a DTRAM_Read. With the data block(s) transferred from the receiver buffer 88 to a destination within the host device, the method includes updating the IVC linked list to remove the data block(s) (step 1114). Updating the OVC linked list to remove the data block requires both a PRAM_Read and a PRAM_Write.

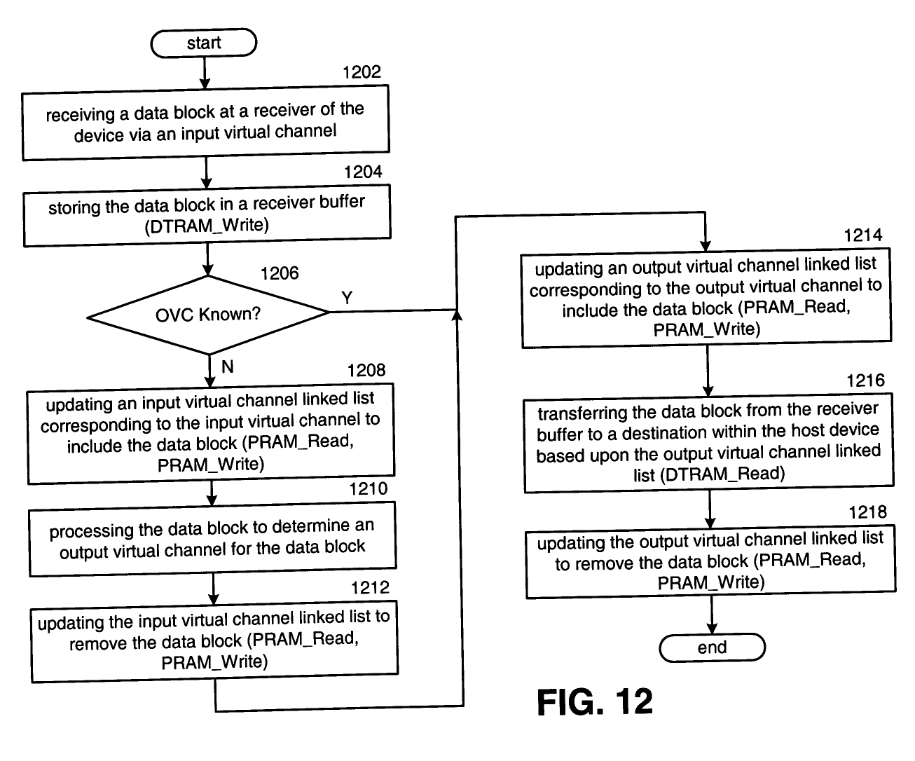

FIG. 12 is a logic diagram illustrating a second embodiment of a method for processing incoming data blocks in accordance with the present invention. The operation of FIG. 12 corresponds to the structure of FIG. 9, which includes the IVC to OVC map 902. The operation commences in receiving a data block at a receiver of the device via an IVC (step 1202). The method includes then storing the data block in a receiver buffer (step 1204). In the operation of step 1204, a DTRAM_Write is performed. Storing the data block in the receiver buffer in step 1204 requires a DTRAM_Write. Next, it is determined whether or not the OVC is known for the received data block on the IVC (step 1206). If the OVC is known, operation proceeds to step 1214, where the OVC linked list corresponding to the OVC is updated to include the data block (step 1214). Adding the data block to the OVC linked list requires one PRAM_Read and one PRAM_Write.

If upon writing the data block in storage in the receiver buffer 88 the OVC is not known (as determined at step 1206), the IVC linked list corresponding to the IVC of the data block is updated to include the data block (step 1208). Adding the data block to the IVC linked list requires one PRAM_Read and one PRAM_Write. The data block is then processed by the routing module 86, perhaps in conjunction with processing the number of other data blocks, to determine an OVC for the data block (step 1210). Once the OVC is determined, the IVC linked list is updated to remove the data block (step 1212) while the OVC linked list is updated to include the data block (step 1214). Each of these operations requires one PRAM_Read and one PRAM_Write. The order of steps 1212 and 1214 may be reversed, but for simplicity in the description of FIG. 12, they are shown in the order indicated.

Eventually, when the switching module 51 determines that the data block or group of data blocks that include a data block is ready for transfer within a transaction cell, the method includes transferring the data block from the receiver buffer 88 to a destination within the host device based upon the OVC linked list (step 1216). This operation requires a DTRAM_Read. Upon transfer, the OVC linked list is updated to remove the data block (step 1218). This operation requires one PRAM_Read and one PRAM_Write. With this operation complete, the data block has been processed and no longer resides within the receiver buffer.

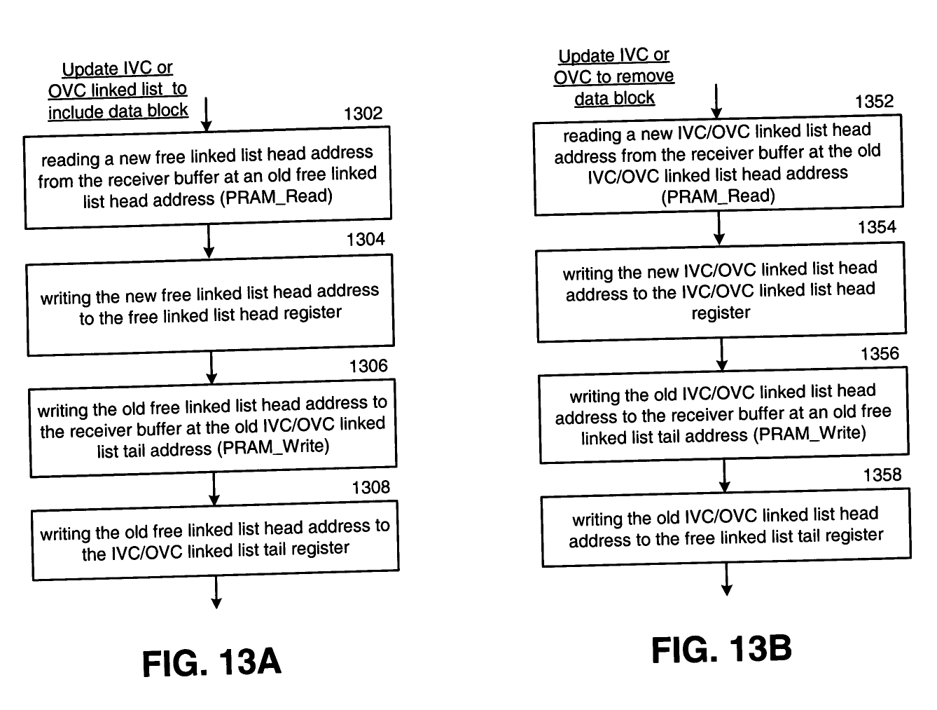

FIG. 13A is a logic diagram illustrating operation in updating a linked list (IVC or OVC) to include a data block. After the data block has been written in the data buffer 88 at a free location of the free linked list, the operation of FIG. 13A is performed. When a free entry is available in the receiver buffer, the address of a next free entry (old free linked list head address) is stored in the free linked list head register. Thus, the data block is written to the data buffer at the old free linked list head address. After the data block has been written, a new free linked list head address is read from the receiver buffer at the old free linked list head address (step 1302). This operation requires one PRAM_Read. The operation of step 1302 may be performed at the same time as the DTRAM is written with the new data block. After this operation, the new free linked list head address is written to the free linked list head register (step 1304). The operation of step 1304 requires writing to a register but does not require access of the receiver buffer via a memory write. Next, the old free linked list head address is written to the receiver buffer in PRAM at an old IVC/OVC linked list tail address (step 1306, one PRAM_Write). By writing the PRAM at this location in step 1306, the address that used to be the tail of the IVC/OVC linked list is no longer the tail because the receiver buffer has been written with the data block at the new tail of the IVC/OVC linked list. Thus, the operation of step 1306 requires a PRAM_Write so that the next to last entry in the IVC/OVC linked list points to the tail of the IVC linked list. Finally, the old free linked list head address is written to an IVC/OVC linked list tail register (step 1308). The operation of step 1308 is also a register write and does not require access of the data buffer. With the operation of step 1308 complete, the IVC/OVC linked list has been updated to include the data block. Such updating includes updating the IVC/OVC tail register, as well as updating the free linked list head register to remove the memory location that has been added to the IVC/OVC linked list.

FIG. 13B is a logic diagram illustrating operation in updating a linked list (IVC or OVC) to remove a data block. Operation of FIG. 13B commences by reading a new IVC/OVC linked list head address from the receiver buffer at the old IVC/OVC linked list head address (step 1352). This operation requires a PRAM_Read. Then, the method includes writing the new IVC/OVC linked list head address to an IVC/OVC linked list head register (step 1354). The operation of step 1354 is a register write and does not require access to the receiver buffer 88. The method proceeds to the step of writing the old IVC/OVC linked list head address to the receiver buffer at an old free linked list tail address (step 1356). This operation requires a single PRAM_Write and adds the newly freed location of the receiver buffer 88 to the tail of the free linked list. Finally, the old IVC/OVC linked list head address is written to a free linked list tail register (step 1358). With step 1358 completed, the IVC/OVC has been updated to remove the data block. As was previously described, the operations of FIG. 13B are performed when one or more data blocks is written from the receiver buffer 88 to the switching module 51 and transfer to another agent. Analogous operations are performed when updating the free linked list to remove an entry.

FIG. 14 is a logic diagram illustrating operation in which both a read operation and a write operation are accomplished in a single read/write cycle. These operations support reading from and writing to an IVC linked list, reading from and writing to an OVC linked list, and reading from an OVC linked list and writing to an IVC linked list. The example of reading from an OVC linked list and writing to an IVC linked list is described in detail with reference to FIG. 11. As was previously described, resources that may be employed to access the receiver buffer 88 include a write port and a read port for each of PRAM, DTRAM, and ERAM. With the operation of FIG. 14, the free linked list is not altered. In such case, a data block is read from the receiver buffer 88 and transferred to the switching module 51, while an incoming data block is written to the newly freed receiver buffer 88 location. This complex operation allows for both the read and write operations to occur in a single read/write cycle.

Operation commences with the step of reading the first data block and a new OVC head address from the receiver buffer at an old OVC head address (step 1402). This particular operation requires a PRAM_Read and a DTRAM_Read. Then, the new OVC head address is written to an OVC channel head register (step 1404). Next, the second data block is written to the receiver buffer at the old OVC head address (step 1406). This operation requires a DTRAM_Write. The nomenclature of FIG. 14 is such that the first data block is read from the receiver buffer and the second data block is written to the receiver buffer. With the second data block having been written to the receiver buffer at a new tail of the IVC, the method includes writing the old OVC head address to the receiver buffer at the old IVC tail address (step 1408). This operation requires a PRAM_Write. Next, the method includes writing the old OVC head address to the IVC tail register (step 1410).

The operations of FIG. 14 may be modified so that the first data block is read from an OVC linked list and the second written to the same OVC linked list, so that the first data block is read from a first OVC linked list and the second written to a second OVC linked list, so that the first data block is read from an IVC linked list and the second written to the same IVC linked list, or so that the first data block is read from a first IVC linked list and the second written to a second IVC linked list.

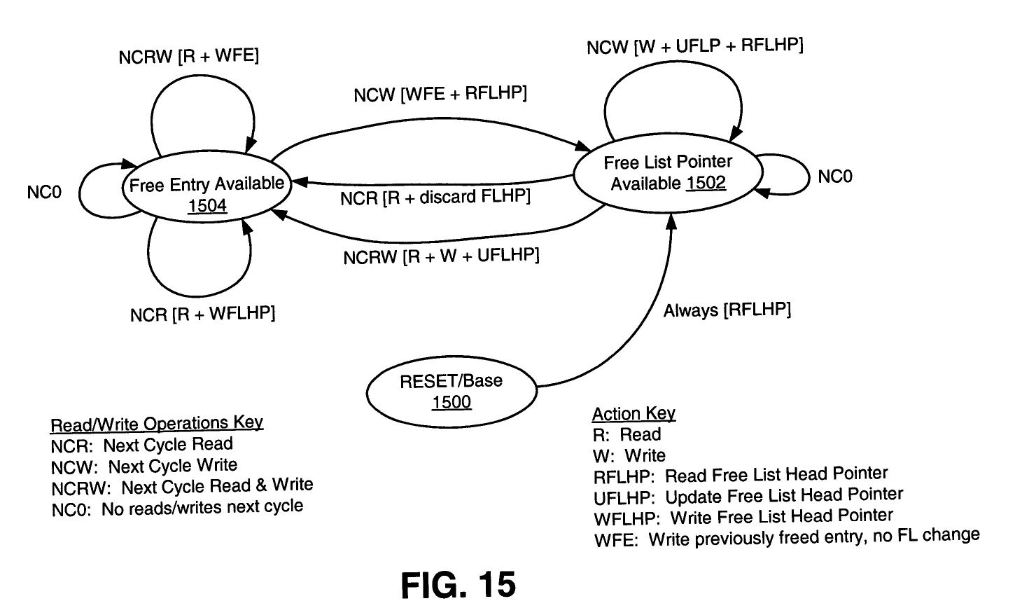

FIG. 15 is a state diagram illustrating operations in accordance with some operations of the present invention in managing receiver buffer contents. Because it is desirable for the system of the present invention to operate as efficiently as possible to process received data blocks, store them, and output them, the present invention includes a technique for anticipating the write of a data block to the receiver buffer 88 in a subsequent read/write cycle. With this operation, a new free linked list head address is read from the receiver buffer at an old free linked list head address in a current read/write cycle. This free linked list head address may be employed during a subsequent read/write cycle if required. However, in the subsequent read/write cycle, if the previously read free linked list head pointer is not required, it is simply discarded.

The states illustrated in FIG. 15 include a reset or base state 1500, a free list pointer available state 1502, and a free entry available state 1504. At power up or reset, operation moves from state 1500 to state 1502 during which a free list head pointer is read. The free list head pointer is read from the receiver buffer 88 at the current free list head address, the address that is read pointing to the next available location in the free linked list. At state 1502 four distinct operations can occur during the next cycle. The next cycle may be a no read/no write cycle (NC0), a next cycle read/write cycle (NCRW), a next cycle write (NCW), or a next cycle read (NCR). When the next cycle is an NC0, no action is taken. However, when the next cycle is a write, the action taken is to write the data block into the receiver buffer, to update the free list pointer, and to read a new free list head pointer from the receiver buffer. In a next cycle read/write operation from state 1502, a read operation is performed, a write operation is performed, and the free list head pointer is updated and operation proceeds to state 1504. When the next cycle is a read, a read is performed, the previously read free list head pointer is discarded, and operation proceeds to state 1504.

Operation from state 1504 can be a no read/no write cycle (NC0), a next cycle read (NCR), a next cycle write (NCW), or a next cycle read/write operation (NCRW). In a next cycle no read/no write, no actions are performed. In a next cycle read operation, a read is performed and the free list head pointer is written. In a next cycle read/write operation, the read operation is performed and the previously freed entry is written with no free list changes. From each of the no read/no write next cycle, next cycle read, and next cycle read/write operations, the state of the system remains in the free entry available state 1504. When the next cycle is a write operation, a write to the previously freed entry is performed and a new free list head pointer is read. With the next cycle write, the state of the system moves from the free entry available state 1504 to the free list pointer available state 1502.

The invention disclosed herein is susceptible to various modifications and alternative forms. Specific embodiments therefore have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims.

1. A method for routing data within a host device comprising:
receiving a data block at a receiver of the host device;
storing the data block in a receiver buffer;
determining an input virtual channel corresponding to the data block;
updating an input virtual channel linked list corresponding to the input virtual channel to include the data block;
determining an output virtual channel for the data block;
transferring the data block from the input virtual channel linked list of the receiver buffer to a destination within the host device via the output virtual channel; and
updating the input virtual channel linked list to remove the data block.

2. The method of claim 1, wherein determining an output virtual channel for the data block includes processing one or more of the input virtual channel, a header corresponding to the data block, a protocol corresponding to the data block, source identifier/address corresponding to the data block, and a destination identifier/address corresponding to the data block.

3. The method of claim 1, wherein:
storing the data block in the receiver buffer includes storing the data block in the receiver buffer at an old free linked list head address; and
updating an input virtual channel linked list corresponding to the input virtual channel to include the data block comprises:
reading a new free linked list head address from the receiver buffer at an old free linked list head address;
writing the new free linked list head address to a free linked list head register;
writing the old free linked list head address to the receiver buffer at the old input virtual channel linked list tail address; and
writing the old free linked list head address to an input virtual channel linked list tail register.

4. The method of claim 1, wherein:
transferring the data block from the input virtual channel linked list of the receiver buffer to a destination within the host device via the output virtual channel includes reading the data block from the receiver buffer at an old input virtual channel linked list head address; and
updating the input virtual channel linked list to remove the data block comprises:
reading a new input virtual channel linked list head address from the receiver buffer at the old input virtual channel linked list head address;
writing the new input virtual channel linked list head address to an input virtual channel linked list head register;
writing the old input virtual channel linked list head address to the receiver buffer at an old free linked list tail address; and
writing the old input virtual channel linked list head address to a free linked list tail register.

5. The method of claim 1, further comprising writing a data block to the receiver buffer and reading a data block from the receiver buffer in a single read/write cycle.

6. The method of claim 1, further comprising anticipating the write of a data block to the receiver buffer in a subsequent read/write cycle by reading a new free linked list head address from the receiver buffer at an old free linked list head address in a current read/write cycle.

7. The method of claim 1, further comprising in a common read/write cycle in which a first data block is read from the receiver buffer and a second data block is written to the receiver buffer:
reading the first data block and a new input virtual channel head address from the receiver buffer at an old input virtual channel head address;
writing the new input virtual channel head address to the input virtual channel head register;
writing the second data block to the receiver buffer at the old input virtual channel head address;
writing the old input virtual channel head address to an input virtual channel tail register; and
writing the old input virtual channel head address to the receiver buffer at an old input virtual channel tail address.

8. The method of claim 1, further comprising supporting a plurality of input virtual channel linked lists, wherein each input virtual channel linked list corresponds to a respective input virtual channel.

9. The method of claim 1, further comprising supporting a free linked list that includes a plurality of vacant data blocks of the receiver buffer.

10. The method of claim 1, further comprising maintaining a mapping indicating a relationship between a plurality of input virtual channels and a plurality of output virtual channels.

11. A method for routing data within a host device comprising:
receiving a data block at a receiver of the host device, the data block received via an input virtual channel;
storing the data block in a receiver buffer;
when the input virtual channel has identified therewith an output virtual channel updating an output virtual channel linked list corresponding to the output virtual channel to include the data block; and
when the input virtual channel has not identified therewith an output virtual channel:
updating an input virtual channel linked list corresponding to the input virtual channel to include the data block;
processing the data block to determine an output virtual channel for the data block;
updating an output virtual channel linked list corresponding to the output virtual channel to include the data block; and
updating the input virtual channel linked list to remove the data block.

12. The method of claim 12, further comprising:
transferring the data block from the receiver buffer to a destination within the host device based upon a corresponding output virtual channel; and
updating the output virtual channel linked list to remove the data block.

13. The method of claim 11, wherein:
storing the data block in the receiver buffer includes storing the data block in the receiver buffer at an old free linked list head address; and
updating an input virtual channel linked list corresponding to the input virtual channel to include the data block comprises:
reading a new free linked list head address from the receiver buffer at an old free linked list head address;
writing the new free linked list head address to a free linked list head register;
writing the old free linked list head address to the receiver buffer at the old input virtual channel linked list tail address; and
writing the old free linked list head address to an input virtual channel linked list tail register.

14. The method of claim 11, further comprising writing a data block to the receiver buffer and reading a data block from the receiver buffer in a single read/write cycle.

15. The method of claim 11, further comprising anticipating the write of a data block to the receiver buffer in a subsequent read/write cycle by reading a new free linked list head address from the receiver buffer at an old free linked list head address in a current read/write cycle.

16. The method of claim 11, further comprising in a common read/write cycle in which a first data block is read from the receiver buffer and a second data block is written to the receiver buffer:
reading the first data block and a new output virtual channel head address from the receiver buffer at the old output virtual channel head address;
writing the new output virtual channel head address to the output virtual channel head register;
writing the second data block to the receiver buffer at the old output virtual channel head address;
writing the old output virtual channel head address to an output virtual channel tail register; and
writing the old output virtual channel head address to the receiver buffer at the old output virtual channel head address.

17. The method of claim 11, further comprising supporting a plurality of input virtual channel linked lists, wherein each input virtual channel linked list corresponds to a respective input virtual channel.

18. The method of claim 11, further comprising supporting a plurality of output virtual channel linked lists, wherein each output virtual channel linked list corresponds to a respective output virtual channel.

19. The method of claim 11, further comprising supporting a free linked list that includes a plurality of vacant data blocks of the input buffer.

20. A received data processing and storage system comprising:
an input that receives data blocks corresponding to a plurality of input virtual channels;
a routing module that determines an output virtual channel for data blocks based upon their respective input virtual channels;
a receiver buffer operable to instantiate an input virtual channel linked list for storing data blocks on an input virtual channel basis and to instantiate a free list that identifies free data locations;
a linked list control module operably coupled to the receiver buffer;
input virtual channel linked list registers operably coupled to the linked list control module; and
free linked list registers operably coupled to the linked list control module.

21. The received data processing and storage system of claim 20, further comprising an output that transmits data blocks corresponding to a plurality of input virtual channels.

22. The received data processing and storage system of claim 20, wherein:
the receiver buffer is further operable to instantiate an output virtual channel linked list for storing data blocks on an output virtual channel basis; and
the system further comprises output virtual channel linked list registers operably coupled to the linked list control module and an input virtual channel to output virtual channel map.

23. The received data processing and storage system of claim 20, wherein the receiver buffer comprises:
a pointer memory; and
a data memory, wherein a single address addresses corresponding locations of the pointer memory and of the data memory.

24. The received data processing and storage system of claim 23, wherein the receiver buffer further comprises a packet status memory, wherein a single address addresses corresponding locations of the pointer memory, the data memory, and the packet status memory.

25. The received data processing and storage system of claim 23, further comprising a pointer memory read port, a pointer memory write port, a data memory read port, and a data memory write port, each of which can access the receiver buffer in a common read/write cycle.

26. The received data processing and storage system of claim 25, wherein:
a single pointer memory location can be read from and written to in a common read/write cycle; and
a single data memory location can be read from and written to in a common read/write cycle.

27. The received data processing and storage system of claim 20, wherein the receiver buffer comprises:
a pointer memory;
a data memory;
a packet status memory; and
wherein a single address addresses corresponding locations of the pointer memory, the data memory, and the packet status memory.

28. The received data processing and storage system of claim 27, further comprising:
a pointer memory read port;
a pointer memory write port;
a data memory read port;
a data memory write port;
a packet status memory read port; and
a packet status memory write port.

29. The received data processing and storage system of claim 28, wherein:
a single pointer memory location can be read from and written to in a common read/write cycle;
a single data memory location can be read from and written to in a common read/write cycle; and
a single packet status memory location can be read from and written to in a common read/write cycle.
